(19) United States
(12) Patent Application Publication
(10) Pub. No.: US 2007/0029820 A1
(43) Pub. Date: Feb. 8, 2007

(54) Tamper evident seal assembly

(75) Inventors: Victor Navarsky, Hokkaido (JP); Hiroko Takasugi, Hokkaido (JP)

Correspondence Address: HOGAN & HARTSON L.L.P., 1999 AVENUE OF THE STARS, SUITE 1400, LOS ANGELES, CA, 90067, US

(73) Assignee: NAVATECH COMPANY LIMITED

(21) Appl. No.: 11/196,576

(22) Filed: Aug. 2, 2005

(51) Int. Cl. G09F 3/03

(52) U.S. Cl. 292/315

(57) ABSTRACT

A tamper evident seal assembly includes an elongated member having a first end and a second end. A housing is adapted to anchor the first end of the elongated member. A hollow member is provided through aligned apertures of a door handle and a door handle bracket of a container. The second end of the elongated member is feed through the hollow member.

### BACKGROUND OF THE INVENTION

1. Field of the Invention

The present invention relates to a tamper evident seal assembly for cargo containers and trucks. More particularly, the present invention is directed to a tamper evident seal assembly for application on doors of cargo containers or trucks in such a manner that prevents the doors from being opened without removing or destroying the seal.

2. Description of the Related Art

FIG. 8 shows a cargo container 22 to be transported on a freight train or the like. It has cargo loading/unloading doors 23 at its front. The doors 23 are mounted at their outer edges to a container body 24 by means of hinges 25 so as to be pivotable outward about the hinges 25.

A plurality of door rods 2 extend vertically at the front of the doors 23 to keep the doors 23 closed. The door rods 2 have both their ends coupled to the container body 24 so as to be rotatable about their axes.

Referring to FIGS. 9A-9D, each door rod 2 has a pair of vertically arranged, outwardly extending jaws 26 at either end thereof. A door closing member 27 is provided on the container body 24 near each jaw 26.

As shown in FIG. 9D, the jaws 26 and the door closing members 27 can be engaged and disengaged by rotating the door rod 2. When they are engaged, the doors 23 of the cargocontainer or truck 22 cannot be opened. Namely, the doors 23 are locked in a closed state.

As shown in FIGS. 8 and 10, the door rod 2 includes a door handle bracket 4 welded thereon to accommodate a door handle 3. The door handle bracket 4 includes a pair of opposing holes (not shown) to receive a solid metal riveted pin member 40. The solid metal riveted pin member 40 includes a head 42 and a base (not shown). The head 42 protrudes slightly out from one of the opposing holes on one of the sides of the door handle bracket 4. The solid metal riveted pin member 40 is provided to secure the door handle 3 within the door handle bracket 4.

Rotating the door handle 3 inward or outward will also turn the door rod 2. By turning the door handle 3 inward to the position close to the surface of the door 23 of the container 22, the jaws 26 of the door rod 2 will engage the door closing member 27 fixed to the container body 24, thus locking the door 23. By turning the door handle 3 outward from this position, the door rod 2 is turned in the direction shown by the arrow in FIG. 9D until the jaws 26 disengage from the door closing members 27. Now the door 23 can be opened in an outward manner.

During transportation, in order to prevent theft of the contents of such a cargo container or truck 22, or loading therein of unauthorized cargo such as narcotics, explosives, weapons or similar materials by criminal perpetrators or terrorists, the door handle 3 of each door rod 2 is fitted in a lever holding/locking member 32 fixed to the surface of the door 23 and locked in position by means of a locking pin or a lever tumbler lock 33 functioning as a seal member as shown in FIG. 10. Once locked in position, the door handle 3 of the door rod 2 cannot be turned outward, so that the door 23 cannot be opened.

But since the door handle 3 of the door rod 2 is simply locked in position by securing it to the surface of the door 23, an unauthorized person can unlock and open the door 23 relatively easily by, e.g., cutting the holding/locking member 32 with a fret saw, or removing it by manipulating and thereby enabling one to turn the door rod 2. Thus, the contents of such conventionally locked cargo containers or trucks 22 are frequently stolen or contraband and other unauthorized articles are loaded therein.

Moreover, the door 23 can be opened by unauthorized persons and then the cargo container 22 can be resealed without leaving any evidence of tampering with the cargo container 22. As shown in FIG. 10 for example, the door handle 3 is secured to the door handle bracket 4 with an original solid metal riveted pin member 40. The head 42 of the solid metal riveted pin member 40 can be cut off with a chisel for example, allowing the removal of the pin member 40. Alternatively, if the head 42 of the solid metal riveted pin member 40 is not provided, the solid metal riveted pin member 40 can be easily removed using a portable battery-operated drill, for example. After the solid metal riveted pin member 40 is removed, the door handle 3 can be released from the door rod 2. With the door handle 3 disconnected, the door rod 2 can be rotated while the seal member 33 remains intact. With the door rod 2 in an open position, the door 23 can be opened while the seal member 33 also remains intact. After the doors 23 has been opened and the contents of the cargo container 22 have been removed, replaced, added or substituted, the door handle 3 can be reattached using a replacement pin such that the tampering of the cargo container 22 cannot be detected.

### SUMMARY OF THE INVENTION

According to an embodiment of the present invention, a tamper evident seal assembly includes an elongated member having a first end and a second end. A housing is adapted to anchor the first end of the elongated member. A hollow member is provided through aligned apertures of a door handle and a door handle bracket of a container. The second end of the elongated member is feed through the hollow member.

### BRIEF DESCRIPTION OF THE DRAWINGS

These and other features, aspects and advantages of the present invention will become better understood with regard to the following description, appended claims and accompanying drawings which:

FIG. 1 is a perspective view of a tamper evident seal assembly according to an embodiment of the present invention showing how the assembly is actually mounted.

FIG. 2 is a perspective view of a tamper evident seal assembly according to an alternative embodiment of the present invention showing how the assembly is actually mounted.

FIG. 3 shows the housing and elongated member having an anchored end for elongated member provided therein according to an embodiment of the present invention.

FIG. 4 shows the housing and elongated member having an anchored end for the elongated member provided therein and a free end for the elongated member according to an embodiment of the present invention.

FIG. 5 shows the housing and elongated member having a male/female connector according to an embodiment of the present invention.

FIG. 6 shows the hollow pin member according to an embodiment of the present invention.

FIG. 7 shows the hollow pin member provided through the door handle and door handle bracket according to an embodiment of the present invention.

FIG. 8 is a perspective view of a container.

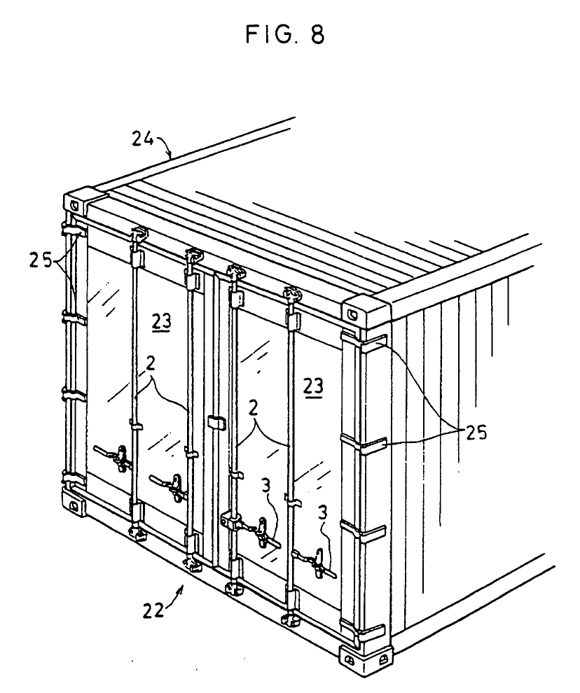

FIGS. 9A to 9D show how jaws of a rod and door closing members are engaged and disengaged.

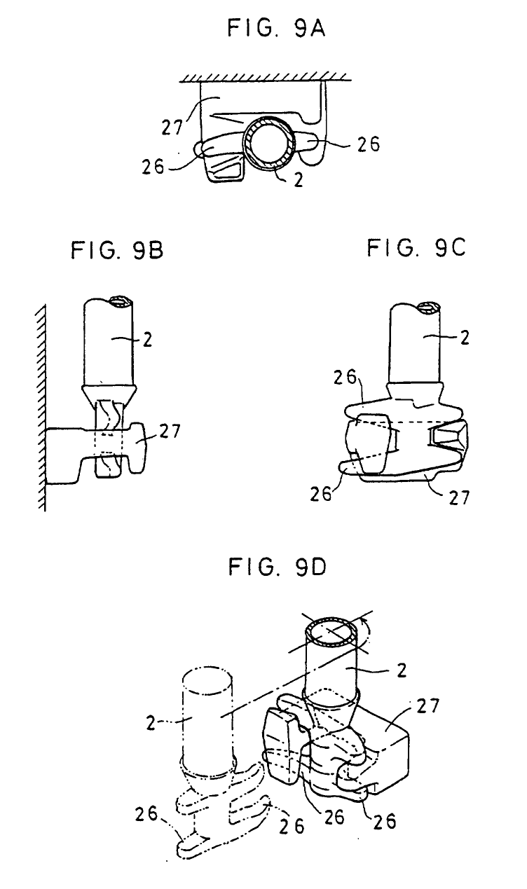

FIG. 10 is a perspective view of a conventional locking device.

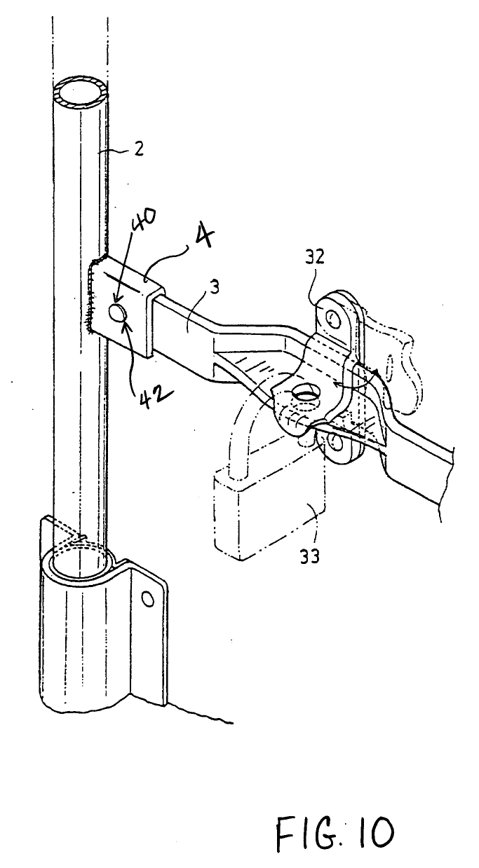

### DETAILED DESCRIPTION OF THE PREFERRED EMBODIMENTS

Now referring to the drawings, descriptions are made of embodiments of a tamper evident seal assembly for cargo containers and trucks.

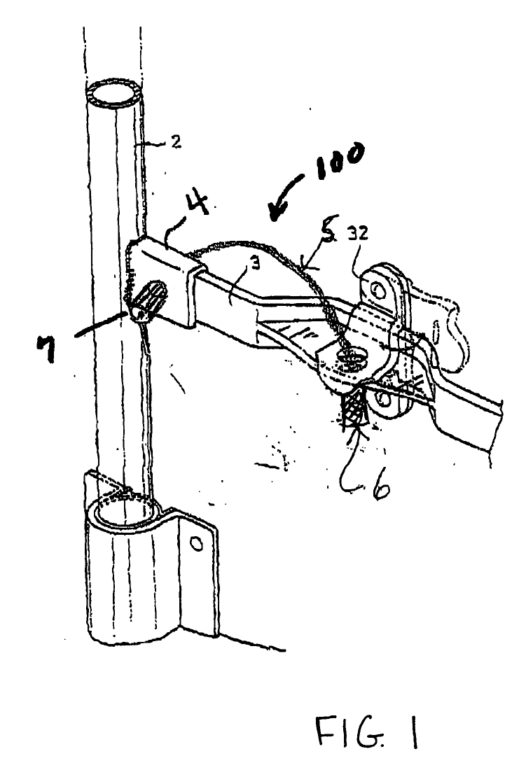

Attention is now directed to FIG. 1 of the drawings in which a tamper evident seal assembly of the present invention is identified with the reference numeral 100. In particular, the tamper evident seal assembly 100 is formed with an elongated member 5 such as a looped wire cable extending through a pair of tabs, eyelets, holes, etc. of the door handle 3 and door handle bracket 4 of the cargo container 22. One end of the elongated member 5 is secured to a hollow pin member 7 of the tamper evident seal assembly 100 and the other end of the elongated member 5 is secured to a housing 6. As shown in FIG. 1, one end of the elongated member 5 passes through an opening of the holding/locking member 32 which also is used for securing a tumbler lock or locking pin before the elongated member 5 is inserted into the housing 6.

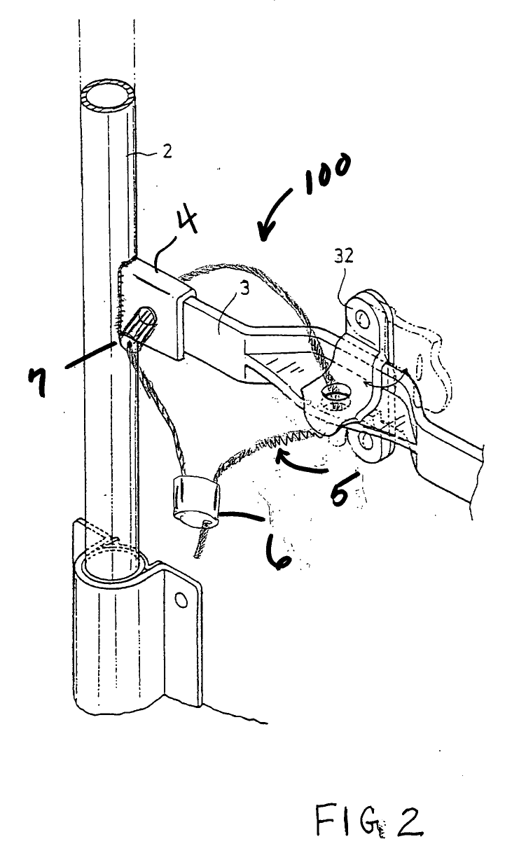

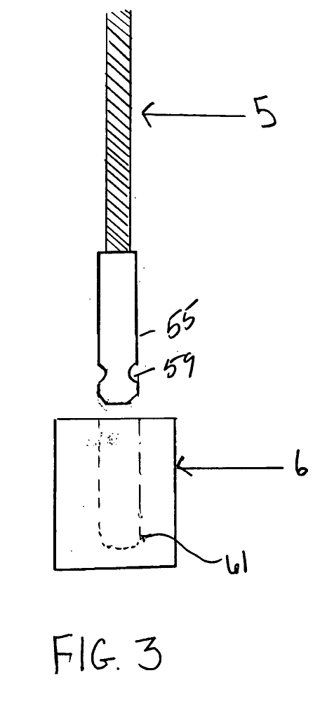

In an alternative embodiment illustrated in FIG. 2, the tamper evident seal assembly 100 includes the elongated member 5 formed in a bight. As shown in FIG. 2, elongated member 5 has both ends terminating in housing 6. One end of elongated member 5 is anchored in housing 6. The other end of elongated member 5 is provided through hollow pin member 7, through the opening of the holding/locking member 32 and eventually through housing 6, thus forming a bight. For a better understanding of the tamper evident seal assembly 100, attention is now directed to FIGS. 3-5 which illustrate various embodiments of the housing 6.

As illustrated in FIG. 3, housing 6 is preferably formed of a plastic material having a specified hardness. Housing 6 is a closed housing which has an internal cavity 61 as shown. According to one embodiment of the present invention, the internal cavity 61 is an anchor cavity. One end of the elongated member 5 is nonreleasably anchored inside the internal cavity 61 of the housing 6. This end of elongated member 5 can be anchored in any manner such that the elongated member 5 permanently remains in the housing 6. For example, the end of elongated member 5 may be enlarged and molded into the plastic housing 6. Alternatively, the end of the elongated member 5 is firmly fitted in a washer and then the washer and the end of the elongated member 5 are molded into the plastic housing 6.

In an alternative embodiment of the present invention, the housing 6 is made of a metal alloy such as steel. When using a steel housing, metal rings are employed and placed around the end of the elongated member 5. The metal rings prevent the elongated member 5 from moving once placed in the steel housing 6. As illustrated in FIG. 3, the elongated member 5 includes an end member 55. The end member 55 is provided around its perimeter with a groove 59. The groove 59 may be used to accommodate the washer or metal rings discussed above.

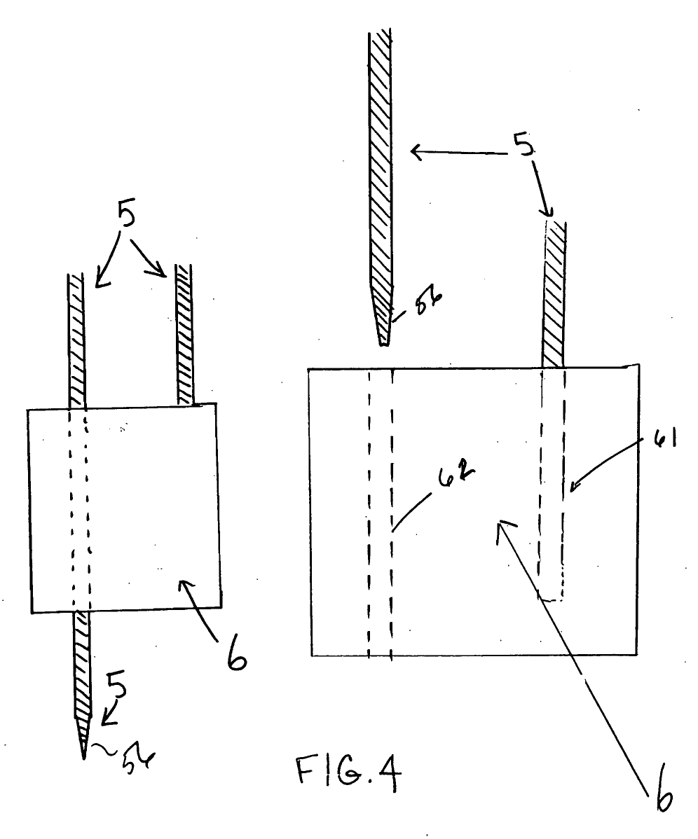

FIG. 4 illustrates an alternative embodiment of housing 6. Housing 6 this time includes two internal cavities 61 and 62. According to one embodiment of the present invention, internal cavity 61 is an anchor cavity. One end of the elongated member 5 is nonreleasably anchored inside the internal cavity 61 of the housing 6. This end of elongated member 5 may be anchored in any manner such that the elongated member 5 permanently remains in the housing 6. For example, the end of elongated member 5 may be enlarged and molded into the plastic housing 6. Alternatively, the end of the elongated member 5 is firmly fitted in a washer and then the washer and the end of the elongated member 5 are molded into the plastic housing 6. In an alternative embodiment of the present invention, the housing 6 is made of a metal alloy such as steel. When using a steel housing, metal rings are employed and placed around the end of the elongated member 5. The metal rings prevent the elongated member 5 from moving once placed in the steel housing 6.

As illustrated in FIG. 4, the other internal cavity is of a sufficient diameter to receive the other end of the elongated member 5. The other end of the elongated member 5, referred to as the free end, includes a tapered end section 56. A base portion of the internal cavity 62 may narrow so that the tapered end section 56 of the elongated member 5 is permitted to pass through in one direction and is positively prevented from withdrawing.

According to an alternative embodiment of the present invention, elongated member 5 may include a coiled section provided above its tapered end section 56. Compared with the tapered end section 56, the coiled section is roughened or corrugated or notched or toothed for firm engagement by locking tongue members (not shown) provided in housing 6. The tongues permit the coiled section of the elongated member 5 to pass between in one direction, but engage the teeth or notches to prevent withdrawal of the elongated member 5.

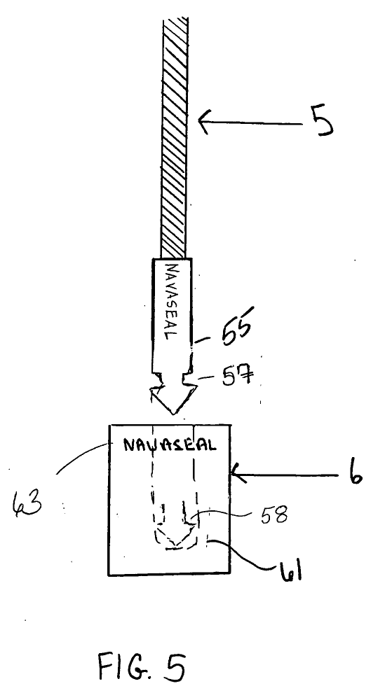

Still in a further embodiment of the present invention, illustrated in FIG. 5, a male/female connector for the elongated member 5 and housing 6 can be incorporated. As shown in FIG. 5, the elongated member 5 includes end member 55. End member 55 terminates in a male connector 57. The male connector 57 can take any shape or form so long as it is adapted to mate with a receiving female connector. Male connector 57 slides within female connector 58 provided in the internal cavity 61 of the housing 6 by supplying sufficient force that will bring together the bifurcated head of male connector 57. Once inside the cavity, the resilient bifurcated head separates lodging itself firmly with cavity 61. This housing is of the type that it cannot be unlocked or release without destroying it.

As illustrated in FIG. 5, on the outside of housing 6, a serial number and/or a bar code 63 may be provided. As discussed in greater detail below, the sealing member 71 and or the pin head 72 of the hollow pin member 7 is provided with the same serial number and/or bar code such that a match between the serial numbers of the housing 6 and pin member 7 indicates that there has been no tampering with the seal.

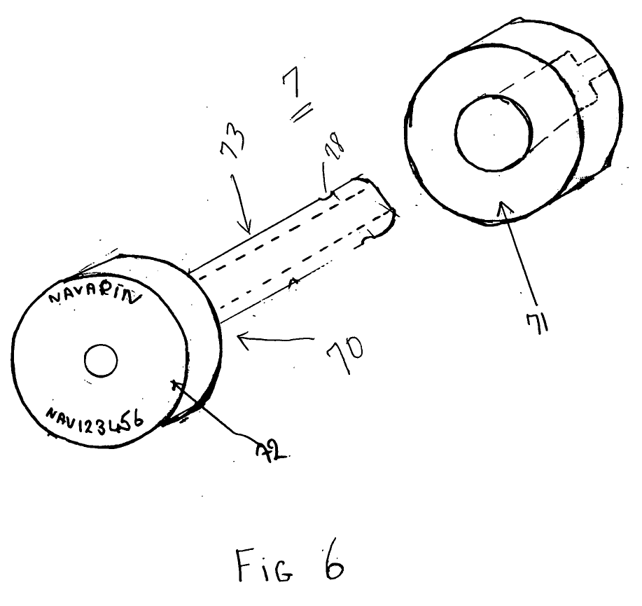

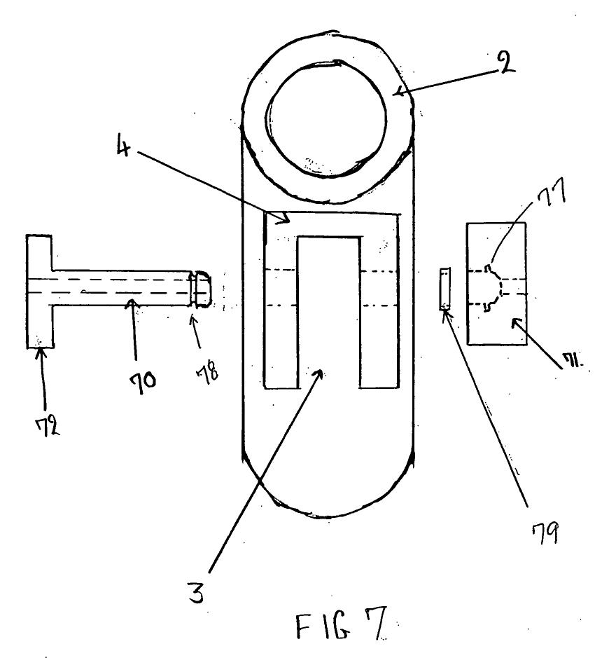

Referring to FIG. 6, the tapered end section 56 of the elongated member 5 is first fed through the hollow pin member 7 before being received by the internal cavity 61 of the housing 6. The hollow pin member 7 includes a hollow pin 70 having a pin head 72, a pin body 73 and a sealing member 71. Hollow pin 70 is a metal pin having a hollow cavity provided therethrough. The hollow cavity has a diameter larger than the diameter of the elongated member 5 in order to accommodate the elongated member 5 in a sufficient and friction-free manner. Referring to FIG. 7, hollow pin 70 is inserted through the respective holes of door handle 3 and door handle bracket 4 to inseparably couple the door handle 3 and the door handle bracket 4. Sealing member 71 also includes a hollow cavity having a diameter larger than the diameter of pin body 73 in order to accommodate the end to pin body 73 therein. The end of pin body 73 may be provided with a flange ending in order to be received by the sealing member 71. The hollow pin member 7 may be made of one part or two parts joined together. The hollow pin member 7 is manufactured of sufficiently strong materials to withstand the normal forces applied when the doors 23 of the cargo container 22 are opened. The sufficiently strong materials may include a metal or a metal alloy such as steel or aluminum or a carbon fiber.

According to an alternative embodiment of the present invention, hollow pin 70 may include an annular spring ring 79 received in a groove 78 formed on its outer periphery near the tip of the hollow pin 70. As shown in FIG. 7, the annular spring ring 79 is received in both the groove 78 formed in the hollow pin 70 and an annular groove 77 formed in the inner periphery of the sealing member 71. As shown in FIG. 7, the groove 78 formed in the hollow pin 70 has its side near the tip of the hollow pin 70 rising steeply and its side near the pin head 72 rising rather moderately. Thus, if trials are made to pull the hollow pin 70 out of the holes of the door handle 3 and the door handle bracket 4, the annular spring 79 will be caught by the edge of the groove 78 near the tip of the hollow pin 70 and the edge of the groove 77 near the tip of the hollow pin 70, so that the hollow pin 70 can never be pulled out of the holes of the door handle 3 and door handle bracket 4.

According to an alternative embodiment of the present invention, hollow pin 70 may be threadably engageable with sealing member 71. Specifically, hollow pin 70 may be provided with male outer threads for threadably engaging sealing member 71 via inner female threads provided in a larger diameter portion of an axial bore or passageway provided in sealing member 71. Between pin head 72 and sealing member 71 is provided elongated member 5 between the cylindrical wall of hollow pin 70.

The elongated member 5 is preferably formed of a substantially strong, yet flexible material. In a preferred embodiment of the present invention, the elongated member 5 is formed of braided or bound metals strands which are generally secured together at opposite ends thereof to form a very strong durable cable type segment. Moreover, as a plurality of individual strands are preferably utilized to make up the preferred elongated member 5, some flexibility is achieved and if the elongated member 5 is cut, the quantity of strands are such that the elongated member 5 cannot be unnoticeably returned to its original form, such as by welding. Furthermore, the elongated member 5 is preferably of a sufficient thickness such that it will be substantially difficult to quickly and easily cut.

According to an alternative embodiment of the present invention, elongated member 5 is cross sprayed with a plastic coating as a further measure to indicated any manipulation in elongated member 5 between its exit and re-entry to and from housing 6. The plastic layer will definitely be damaged during an attempt to use heat to release the elongated member 5 from its anchorage in housing 6 and thus makes such an unsuccessful manipulation visible.

As stated previously, elongated member 5 may include tapered end section 56 and also an anchored end section which are preferably spaced apart from one another. For example, although not preferred, it may be desirable for the elongated member 5 to extend across the adjacent doors 23. Nevertheless, in a preferred embodiment of the present invention, the elongated member 5 is approximately twenty to thirty centimeters in length and sixty centimeters in length if a bite is used so as to achieve the preferred interconnection. Of course, the ultimate actual length and make up of the elongated member 5 may vary depending upon the actual scale of the cargo container 22 and the spaced apart nature of the various components through which the elongated member 5 is to extend.

The invention has been described in terms of presently preferred embodiments thereof. Other embodiments within the scope and spirit of the present invention as defined by the appended claims will occur to those having ordinary skill in the art upon reading the disclosure.

What is claimed is:

1. A tamper evident seal assembly, comprising:
an elongated member having a first end and a second end;
a housing adapted to anchor the first end of the elongated member; and
a hollow member being provided through aligned apertures of a door handle and a door handle bracket of a container, the second end of the elongated member feed through the hollow member.

2. The tamper evident seal assembly according to claim 1, wherein the hollow member is a pin member having a locking mechanism.

3. The tamper evident seal assembly according to claim 1, further comprising a sealing member wherein the housing and the sealing member include a matching serial number.

4. The tamper evident seal assembly according to claim 3, wherein the housing is adapted to receive the second end of the elongated member and the elongated member is feed through the hollow member and the sealing member and then to the housing forming a bight.

5. The tamper evident seal assembly according to claim 1, wherein the housing includes internal cavities.

6. The tamper evident seal assembly according to claim 1, wherein the elongated member is made of a metal.

7. The tamper evident seal assembly according to claim 1, wherein the elongated member includes a tapered section.

8. The tamper evident seal assembly according to claim 1, wherein the elongated member includes a coiled section.

9. The tamper evident seal assembly according to claim 1, wherein the housing is made of plastic.

10. A method for securing a tamper evident seal assembly, comprising:
anchoring a first end of an elongated member in a housing;
inserting a hollow member through aligned apertures of a door handle and a door handle bracket; and
inserting a second end of the elongated member through the hollow member.

11. The method according to claim 10, further comprising securing the second end of the elongated member in the housing.

12. The method according to claim 10, further comprising forming a bight with the elongated member.

13. The method according to claim 10, further comprising providing a matching serial number on the housing and a sealing member of the hollow member.

14. The method according to claim 10, further comprising providing a matching bar code on the housing and a sealing member of the hollow member.

15. A tamper evident seal assembly, comprising:
an elongated member having a first end and a second end;
means for anchoring the first end of the elongated member in a housing; and
a hollow member being provided through aligned apertures of a door handle and a door handle bracket of a container, the second end of the elongated member feed through the hollow member.

16. The tamper evident seal assembly according to claim 15, wherein the elongated member includes a coiled section.

17. The tamper evident seal assembly according to claim 15, wherein the housing and a sealing member of the hollow member include a matching serial number.

18. The tamper evident seal assembly according to claim 15, wherein the housing and the means for securing include a matching bar code.

19. The tamper evident seal assembly according to claim 15, wherein the housing includes internal cavities.

20. The tamper evident seal assembly according to claim 15, wherein the elongated member is made of a metal.
